(19) United States
(12) Patent Application Publication
(10) Pub. No.: US 2007/0263005 A1
(43) Pub. Date: Nov. 15, 2007

(54) Liquid crystal display panel, timing control device thereof, and method for generating overdrive parameters for the same

(75) Inventors: Chun-Hung Huang, Hsin-Chu (TW); Heng-Sheng Chou, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsinchu (TW)

(21) Appl. No.: 11/711,604

(22) Filed: Feb. 28, 2007

(30) Foreign Application Priority Data
May 12, 2006 (TW) 95117005

(51) Int. Cl. G09G 5/36

(52) U.S. Cl. 345/546

(57) ABSTRACT

A timing control device including a first buffer device, a second buffer device, and an overdrive unit in a liquid crystal display panel outputs overdrive parameters according to previous and current frames. A first buffer unit of the first buffer device stores an i-th one of pieces of current frame data at a first time point. A second buffer unit of the second buffer device stores an i-th one of pieces of previous frame data. The overdrive unit outputs an i-th overdrive parameter corresponding to the i-th piece of current frame data according to the i-th piece of previous frame data stored in the second buffer unit and the i-th piece of current frame data. At a different second time point, the i-th piece of current frame data stored in the first buffer device or one of the pieces of previous frame data is sent to the second buffer unit.

This application claims the benefit of Taiwan Patent Application Serial No. 95117005, filed May 12, 2006, the subject matter of which is incorporated herein by reference.

### BACKGROUND OF THE INVENTION

1. Field of the Invention

The invention relates in general to a liquid crystal display (LCD) panel, a timing controller thereof, and a method for generating overdrive parameters for the same and more particularly to an LCD panel that uses reduced buffering space, a timing controller thereof, and a method for generating overdrive parameters for the same that uses reduced buffering space.

2. Description of the Related Art

Referring to FIG. 1, an LCD panel driven by a conventional overdrive method is illustrated. The conventional LCD panel 100 includes memory 102 and memory 104, timing control device 106, compensation table 108, driving circuit 110, and pixel array 112. The driving circuit 110, for example, including a gate driver and a source driver, is used for driving the pixel array 112. The timing control device 106 is used for outputting overdrive pixel data to the source driver when overdrive is performed. Based on a previous frame PF0 and a current frame CF0, corresponding overdrive pixel data of the current frame CF0 is generated by the timing control device 106 according to the compensation table 108.

In order to facilitate the timing control device 106 to generate overdrive pixel data corresponding to the current frame CF0 according to the previous frame PF0 and the current frame CF0, the conventional LCD panel 100 employs the memory 102 and memory 104 each having enough memory space for storing data of an entire frame. The memory 102 stores the entire pixel data of the previous frame PF0 while the memory 104 stores the entire pixel data of the current frame CF0. The timing control device 106 then generates an overdrive parameter corresponding to a specific pixel according to pixel data corresponding to the specific pixel read from the memory 102 and from the memory 104.

However, the memory 102 and memory 104 used by the conventional LCD panel 100 have to provide large memory space to store entire pixel data of the previous frame PF0 and current frame CF0, and this inevitably leads to an increase in hardware cost for the memory devices. In addition, the memory devices occupy large area on the circuit board, and the cost on the circuit board is also increased. Thus, it is desirable in this field to reduce the cost of an overdriven liquid crystal display.

### SUMMARY OF THE INVENTION

The invention is directed to a liquid crystal display panel, a timing control device thereof, and a method for generating overdrive parameters for the same. A reduced memory space required for overdriving the liquid crystal display panel can be achieved. The total cost and circuit board space are also reduced accordingly.

According to a first aspect of the invention, an apparatus for timing control is provided for use in a liquid crystal display panel, for outputting M overdrive parameters according to a previous frame and a current frame, wherein M is a positive integer, the previous frame includes M pieces of previous frame data, and the current frame includes M pieces of current frame data. The apparatus includes a first buffer device, a second buffer device, and an overdrive unit. The first buffer device includes a first buffer unit, wherein the first buffer unit is used for storing an i-th one of the M pieces of current frame data at a first time point, wherein i is a positive integer not larger than M. The second buffer device includes a second buffer unit, wherein the second buffer unit is used for storing an i-th one of the M pieces of previous frame data. The overdrive unit is for outputting an i-th overdrive parameter which corresponds to the i-th piece of current frame data according to the i-th piece of previous frame data stored in the second buffer unit and the i-th piece of current frame data. One of the first buffer device and the second buffer device further includes a plurality of buffer units. At least a portion of the M pieces of previous frame data is stored in one of the first buffer device and the second buffer device. At a second time point, the i-th piece of current frame data stored in the first buffer device or one of the M pieces of previous frame data is sent to the second buffer unit, the second time point being different from the first time point.

According to a second aspect of the invention, a liquid crystal display panel is provided. The liquid crystal display panel includes a pixel array comprising a plurality of pixels, a driving circuit for driving the pixel array, and a timing control device. The timing control device is used for controlling the driving circuit and outputting M overdrive parameters according to a previous frame and a current frame, wherein M is a positive integer, the previous frame includes M pieces of previous frame data, and the current frame includes M pieces of current frame data. The timing control device includes a first buffer device, a second buffer device, and an overdrive unit. The first buffer device includes a first buffer unit for storing an i-th one of the M pieces of current frame data at a first time point, wherein i is a positive integer not larger than M. The second buffer device includes a second buffer unit for storing an i-th one of the M pieces of previous frame data. The overdrive unit is used for outputting an i-th overdrive parameter which corresponds to the i-th piece of current frame data according to the i-th piece of previous frame data stored in the second buffer unit and the i-th piece of current frame data. One of the first buffer device and the second buffer device further includes a plurality of buffer units. At least a portion of the M pieces of previous frame data is stored in one of the first buffer device and the second buffer device. At a second time point, the i-th piece of current frame data stored in the first buffer device or one of the M pieces of previous frame data is sent to the second buffer unit; and the second time point being different from the first time point. The driving circuit generates a corresponding pixel voltage according to the i-th overdrive parameter so as to drive a corresponding pixel in the pixel array.

According to a third aspect of the invention, a method for generating overdrive parameters is provided for use in a liquid crystal display panel. The method is for outputting M overdrive parameters according to a previous frame and a current frame, wherein the previous frame including M pieces of previous frame data, and the current frame including M pieces of current frame data. The method includes the following steps. (a) At a first time point, an i-th one of the M pieces of current frame data is stored in a first buffer unit of a first buffer device, wherein i is a positive integer not larger than M. (b) An i-th one of the M pieces of previous frame data is stored in a second buffer unit of a second buffer device, wherein at least a portion of the M pieces of previous frame data is stored in one of the first buffer device and the second buffer device. (c) At a second time point, the second buffer unit receives the i-th piece of current frame data or one of the M pieces of previous frame data from the first buffer device. (d) An i-th overdrive parameter which corresponds to the i-th piece of current frame data is outputted according to the i-th piece of previous frame data in the second buffer unit and the i-th piece of current frame data.

The invention will become apparent from the following detailed description of the preferred but non-limiting embodiments. The following description is made with reference to the accompanying drawings.

### BRIEF DESCRIPTION OF THE DRAWINGS

FIG. 1 (Related Art) shows a conventional liquid crystal display panel using an overdrive technique.

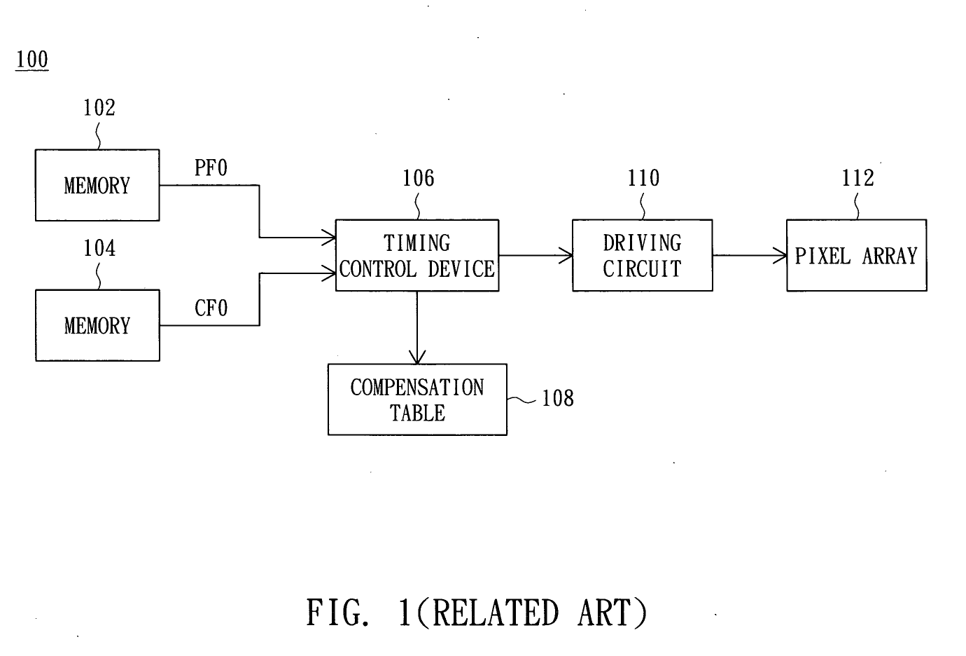

FIG. 2 is a block diagram illustrating a liquid crystal display panel according to a preferred embodiment of the invention.

FIG. 3 is a block diagram illustrating a liquid crystal display panel according to a first example of the preferred embodiment.

FIG. 4 is a block diagram illustrating a liquid crystal display panel according to a second example of the preferred embodiment.

### DETAILED DESCRIPTION OF THE INVENTION

According to the invention, a buffer having memory space large enough to store entire data of a frame and another buffer having smaller memory space are used in a timing control device of an LCD panel to generate overdrive pixel data corresponding to a current frame according to the current frame and a previous frame. As compared to using two buffers each being required to store entire data of a frame conventionally, the memory space required by the timing control device is reduced in accordance with the invention, saving area on circuit board occupied by memory required and lowering the cost of the LCD panel.

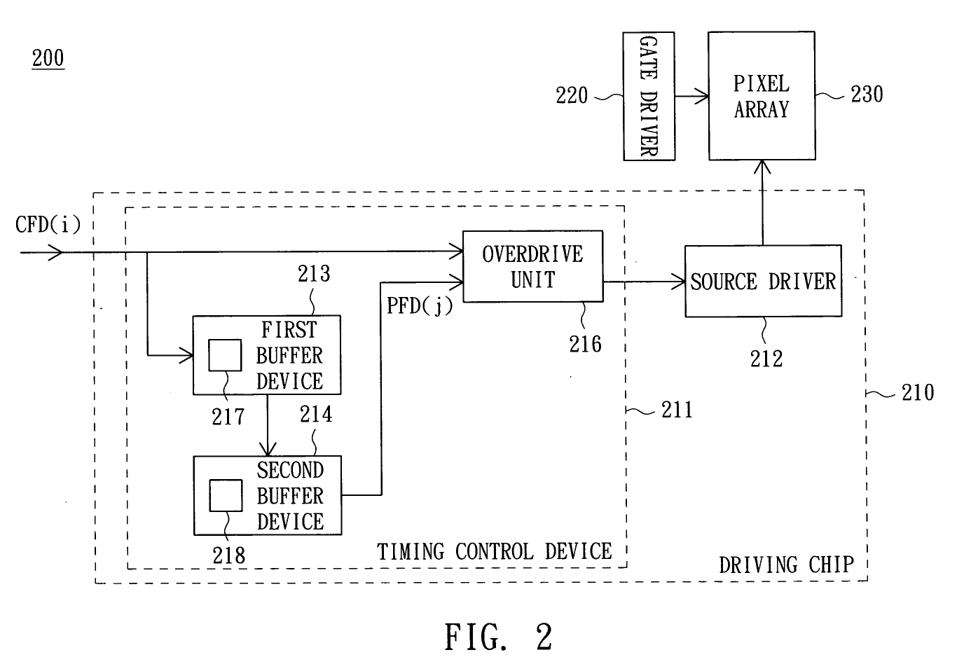

Referring to FIG. 2, an LCD panel according to a preferred embodiment of the invention is shown. An LCD panel 200 includes a driving chip 210, a gate driver 220, and a pixel array 230. The driving chip 210 includes a timing control device 211 and a source driver 212. The timing control device 211 includes a first buffer device 213, a second buffer device 214, and an overdrive unit 216. The LCD panel 200 is used for displaying a previous frame PF and a current frame CF. The current frame CF includes M pieces of current frame data, denoted by CFD(1) to CFD(M), where M is a positive integer. The previous frame PF includes M pieces of previous frame data, denoted by PFD(1) to PFD(M). The timing control device 211 generates M overdrive parameters corresponding to the M pieces of current frame data CFD(1) to CFD(M) according to the M pieces of current frame data CFD(1) to CFD(M) and the M pieces of previous frame data PFD(1) to PFD(M). The M pieces of current frame data CFD(1) to CFD(M) are inputted sequentially and stored in the first buffer device 213, for example.

As an example of how the LCD panel 200 generates overdrive parameters, an overdrive parameter corresponding to an i-th piece of current frame data CFD(i) is to be generated as follows, where i is a positive integer smaller than or equal to M, i.e. not larger than M. The first buffer device 213 includes a first buffer unit 217, and the second buffer device 214 includes a second buffer unit 218. One of the first buffer device 213 and second buffer device 214, for example, may further include a number of buffer units (not shown). At least a portion of the M pieces of previous frame data PFD(1) to PFD(M) is stored in one of the first buffer device 213 and second buffer device 214. At a first time point, an i-th piece of current frame data CFD(i) is inputted to the first buffer device 213 and stored in the first buffer unit 217 of the first buffer device 213. At a second time point, the i-th piece of current frame data CFD(i) stored in the first buffer unit 217 or one of the M pieces of previous frame data stored in the first buffer unit 217 is sent to a second buffer unit 218 of the second buffer device 214, wherein the second time point is different from the first time point. The overdrive unit 216 generates an i-th overdrive parameter corresponding to the i-th piece of current frame CFD(i) according to the i-th piece of current frame CFD(i) and an i-th piece of previous frame data PFD(i) outputted from the second buffer device 214. Accordingly, the source driver 212 controls the pixel array 230 according to the i-th overdrive parameter.

The following two examples illustrate two ways of generating overdrive parameters for the LCD panel 200 of the preferred embodiment of the invention.

### EXAMPLE ONE

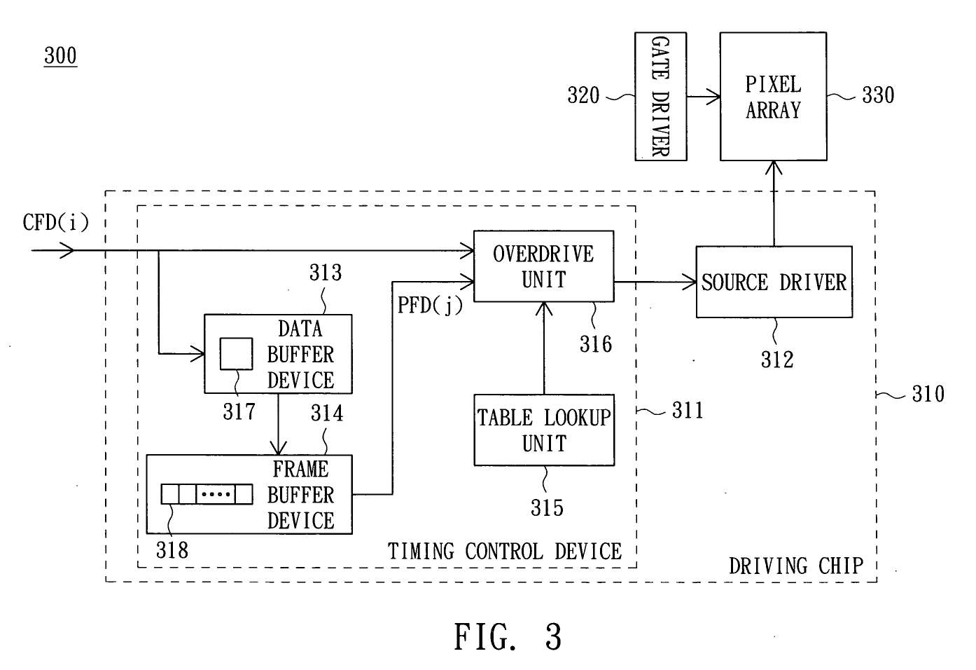

Referring to FIG. 3, an LCD panel of an example one is shown in block diagram form. An LCD panel 300 includes a driving chip 310, a gate driver 320, and a pixel array 330. The driving chip 310 includes a timing control device 311 and a source driver 312. The timing control device 311 includes a data buffer device 313, a frame buffer device 314, a table lookup unit 315, and an overdrive unit 316. In this example, the first buffer device 213 and second buffer device 214, as shown in FIG. 2, are implemented by the data buffer device 313 and frame buffer device 314 respectively. The data buffer device 313 can include a number of first buffer unit 317, where the number of first buffer unit 317 is not larger than the number of pieces of data in a pixel row of a frame. In this example, the data buffer device 313 includes a first buffer unit 317, and the frame buffer device 314 includes M second buffer unit 318 for storing M pieces of data.

Regarding an i-th piece of current frame data CFD(i), the following gives an example of how the timing control device 311 of the LCD panel 300 generates a corresponding overdrive parameter. In this example, at least a portion of the M pieces of previous frame data PFD(1) to PFD(M) is stored in the frame buffer device 314. At a first time point, an i-th piece of current frame data CFD(i) is inputted to the first buffer unit 317 of the data buffer device 313. In addition, the i-th piece of current frame data CFD(i) is sent to the overdrive unit 316 at the first time point. At a second time point, the i-th piece of current frame data CFD(i) stored in the first buffer unit 317 is sent to one of the second buffer units 318 of the frame buffer device 314, wherein the second time point is later than the first time point. The overdrive unit 316, preferably, is configured to access information stored in the table lookup unit 315 according to the i-th piece of current frame data CFD(i) and an i-th piece of previous frame data PFD(i) outputted from the frame buffer device 314 so as to output an i-th overdrive parameter corresponding to the i-th piece of current frame data CFD(i). The source driver 312 controls the pixel array 230 according to the i-th overdrive parameter, wherein the M overdrive parameters can be overdrive gray-level values.

In the above process of generating overdrive parameters, the frame buffer device 314 stores the first to i-th pieces of current frame data, CFD(1) to CFD(i), of the M pieces of current frame data, and stores the (i+1)th to M-th pieces of previous frame data, PFD(i+1) to PFD(M), of the M pieces of previous frame data. After the pieces of current frame data CFD(1) to CFD(M) have been inputted sequentially, at a next time point, the frame buffer device 314 stores entire frame data of the current frame data CFD(1) to CFD(M) for the generation of overdrive gray-level values corresponding to a next frame.

As illustrated above, the data buffer device 313 is required to store at least one piece of pixel data of a frame, not the entire data of the frame. As compared to the memory 102 that is conventionally required to store entire data of a frame, the data buffer device 313 can be implemented with smaller size and cost than the memory 102 can be, thereby arriving at a reduction in manufacturing cost.

### EXAMPLE TWO

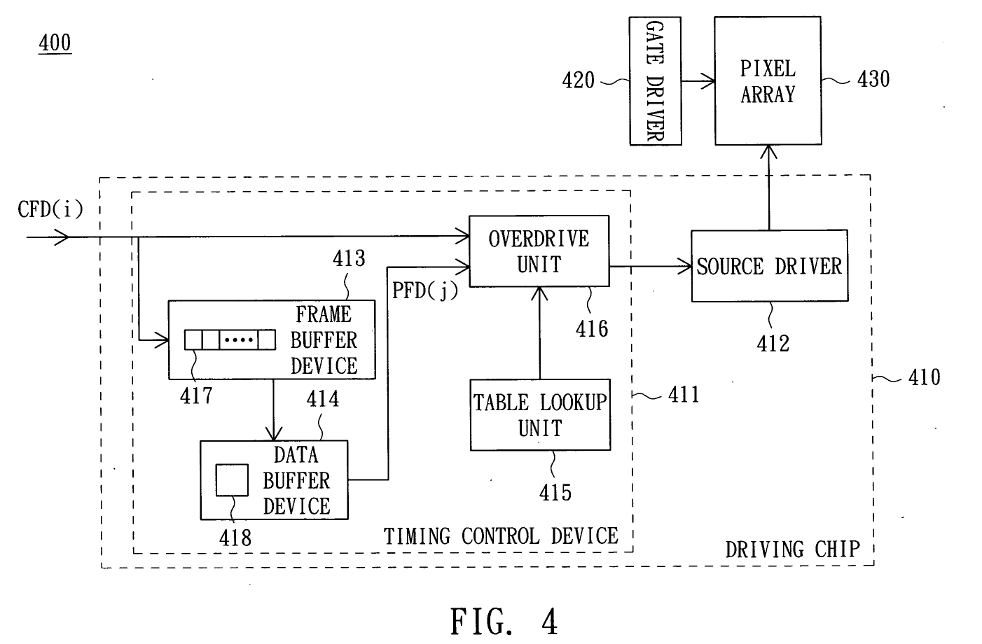

Referring to FIG. 4, an LCD panel of an example two is shown in block diagram form. An LCD panel 400 includes a driving chip 410, a gate driver 420, and a pixel array 430. The driving chip 410 includes a timing control device 411 and a source driver 412. The timing control device 411 includes a frame buffer device 413, a data buffer device 414, a table lookup unit 415, and an overdrive unit 416. The data buffer device 414, for instance, may include a number of second buffer units 418, wherein the number of the second buffer units 418 is smaller than or equal to the number of pieces of data of a pixel row in a frame. In this example, the data buffer device 414 includes a second buffer unit 418. The frame buffer device 413 includes M first buffer unit 417 for storing M pieces of data. The LCD panel 400 differs from the LCD panel 300 of the example one in using the frame buffer device 413 and data buffer device 414, instead of the data buffer device 313 and frame buffer device 314 of FIG. 3.

Regarding an i-th piece of current frame data CFD(i), the following illustrates how the timing control device 411 of the LCD panel 400 generates a corresponding overdrive parameter. In this example, at least a portion of the M pieces of previous frame data PFD(1) to PFD(M) is stored in the frame buffer device 413. The i-th piece of current frame data CFD(i) is sent to the overdrive unit 416 at a second time point. In addition, one of the pieces of previous frame data stored in the frame buffer device 413, such as the i-th piece of previous frame data PFD(i), is sent to the second buffer unit 418 of the data buffer device 414, at the second time point. At a first time point that is after the second time point, the i-th piece of current frame data CFD(i) is inputted to one of the first buffer units 417 of the frame buffer device 413. In addition, the i-th piece of previous frame data PFD(i) is sent to the overdrive unit 416 at the first time point. The overdrive unit 416, preferably, is configured to access information from the table lookup unit 415 according to the i-th piece of current frame data CFD(i) and an i-th piece of previous frame data PFD(i) outputted from the second buffer unit 418 so as to output an i-th overdrive parameter corresponding to the i-th piece of current frame data CFD(i) to the source driver 412. The source driver 412 controls the pixel array 430 according to the i-th overdrive parameter.

Further, at the first time point, the frame buffer device 413 stores the first to i-th pieces of current frame data, CFD(1) to CFD(i), of the M pieces of current frame data, and the (i+1)th to M-th pieces of previous frame data, PFD(i+1) to PFD(M), of the M pieces of previous frame data.

The data buffer device 313 of example one, as well as the data buffer device 414 of example two, can be implemented with a line buffer if the number of the corresponding first buffer units is equal to the pixel number of a pixel row of a frame. That is, when the data buffer device 313 is a line buffer, the data buffer device 313 is able to store data of a pixel row at the same time. The data of the pixel row can be outputted to the frame buffer device 314 piece by piece in series, or one pixel row in parallel at a time. When the data buffer device 414 is a line buffer, the data buffer device 414 is able to store data of a pixel row at the same time. The data of the pixel row can be sent from the frame buffer device 413 piece by piece in series, or one pixel row in parallel at a time.

As disclosed in the above embodiments, the liquid crystal display panel employs a frame buffer device and a data buffer device to temporarily store a portion of frame data of a previous frame and a portion of frame data of a current frame, and obtains corresponding overdrive parameters of the current frame according to the previous frame data and current frame data. Since the data buffer device is required to store at least one or more pieces of frame data, not the entire frame data, the requirement of memory for the LCD display panel according to the invention is significantly reduced, as compared with the conventional LCD display panel requiring memory capable of storing entire data of two frames. Reduced cost of the LCD display panel is effectively achieved accordingly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A timing control apparatus for use in a liquid crystal display panel, the apparatus being configured to output M overdrive parameters according to a previous frame and a current frame, where M is a positive integer, the previous frame including M pieces of previous frame data, the current frame including M pieces of current frame data, the timing control apparatus comprising:
a first buffer device including a first buffer unit for storing an i-th one of the M pieces of current frame data at a first time point, where i is a positive integer not greater than M;
a second buffer device including a second buffer unit for storing an i-th one of the M pieces of previous frame data; and
an overdrive unit for outputting an i-th overdrive parameter which corresponds to the i-th piece of current frame data, according to the i-th piece of previous frame data stored in the second buffer unit and the i-th piece of current frame data;
wherein one of the first buffer device and the second buffer device further includes a plurality of buffer units,
at least a portion of the M pieces of previous frame data is stored in one of the first buffer device and the second buffer device; and
at a second time point, the i-th piece of current frame data stored in the first buffer device or one of the M pieces of previous frame data is sent to the second buffer unit, the second time point being different from the first time point.

2. The timing control apparatus according to claim 1, wherein:
the first buffer device includes X first buffer units for storing X of the M pieces of current frame data respectively, where X is not larger than number of pieces of data in a pixel row of the current frame;
the second buffer device includes M second buffer units for storing at least a portion of the M pieces of previous frame data;
wherein the ith piece of current frame data stored in the first buffer device is sent to one of the M second buffer units at the second time point, and the second time point is subsequent to the first time point.

3. The timing control apparatus according to claim 2, wherein after the second time point, the second buffer device stores a first to the ith ones of the M pieces of current frame data and an (i+1)-th to an M-th ones of the M pieces of previous frame data.

4. The timing control apparatus according to claim 2, wherein the overdrive unit is configured to receive the i-th piece of current frame data at the first time point, wherein the overdrive parameters are overdrive gray-level values.

5. The timing control apparatus according to claim 1, wherein
the first buffer device includes M first buffer units for storing at least a portion of the M pieces of previous frame data and a first to the i-th pieces of current frame data;
the second buffer device includes X second buffer units for storing X of the M pieces of previous frame data, wherein X is the number of pieces of data in a pixel row of the previous frame; and
one of the pieces of previous frame data stored in the first buffer device is sent to one of the X second buffer units at the second time point, and the second time point is prior to the first time point.

6. The timing control apparatus according to claim 5, wherein after the first time point, the first buffer device stores the first to the i-th ones of the M pieces of current frame data and an (i+1)-th to an M-th ones of the M pieces of previous frame data.

7. The timing control apparatus according to claim 5, wherein the overdrive unit is configured to receive the i-th piece of current frame data at the second time point, wherein the overdrive parameters are overdrive gray-level values.

8. The timing control apparatus according to claim 1, further comprising a table lookup unit, wherein the overdrive unit is configured to access the table lookup unit according to the i-th piece of current frame data and the i-th piece of previous frame data so as to output the i-th overdrive parameter.

9. A liquid crystal display panel comprising:
a pixel array comprising a plurality of pixels;
a driving circuit for driving the pixel array; and
a timing control device for controlling the driving circuit and outputting M overdrive parameters according to a previous frame and a current frame, wherein M is a positive integer, the previous frame includes M pieces of previous frame data, and the current frame includes M pieces of current frame data, the timing control device comprising:
a first buffer device including a first buffer unit, the first buffer unit being used for storing an i-th one of the M pieces of current frame data at a first time point, wherein i is a positive integer not larger than M;
a second buffer device including a second buffer unit, the second buffer unit being used for storing an i-th one of the M pieces of previous frame data; and
an overdrive unit for outputting an i-th overdrive parameter which corresponds to the i-th piece of current frame data according to the i-th piece of previous frame data stored in the second buffer unit and the i-th piece of current frame data;
wherein one of the first buffer device and the second buffer device further includes a plurality of buffer units;
at least a portion of the M pieces of previous frame data is stored in one of the first buffer device and the second buffer device;
at a second time point, the i-th piece of current frame data stored in the first buffer device or one of the M pieces of previous frame data is sent to the second buffer unit; and the second time point being different from the first time point;
wherein the driving circuit generates a corresponding pixel voltage according to the i-th overdrive parameter so as to drive a corresponding pixel in the pixel array.

10. The liquid crystal display panel according to claim 9, wherein
the first buffer device includes X first buffer units for storing X of the M pieces of current frame data respectively; X is not larger than number of pieces of data in a pixel row of the current frame;
the second buffer device includes M second buffer units for storing at least a portion of the M pieces of previous frame data;
wherein the i-th piece of current frame data stored in the first buffer device is sent to one of the M second buffer units at the second time point, and the second time point is subsequent to the first time point.

11. The liquid crystal display panel according to claim 10, wherein after the second time point, the second buffer device stores a first to the i-th ones of the M pieces of current frame data and an (i+1)th to an M-th ones of the M pieces of previous frame data.

12. The liquid crystal display panel according to claim 10, wherein the overdrive unit receives the i-th piece of current frame data at the first time point substantially, wherein the overdrive parameters are overdrive gray-level values.

13. The liquid crystal display panel according to claim 9, wherein
the first buffer device includes M first buffer units for storing at least a portion of the M pieces of previous frame data and a first to the i-th pieces of current frame data;
the second buffer device includes X second buffer units for storing X of the M pieces of previous frame data, wherein X is not larger than number of pieces of data in a pixel row of the previous frame;
one of the pieces of previous frame data stored in the first buffer device is sent to one of the X second buffer units at the second time point, and the second time point is prior to the first time point.

14. The liquid crystal display panel according to claim 13, wherein after the first time point, the first buffer device stores the first to the i-th ones of the M pieces of current frame data and an (i+1)th to an M-th ones of the M pieces of previous frame data.

15. The liquid crystal display panel according to claim 13, wherein the overdrive unit receives the i-th piece of current frame data at the second time point substantially, wherein the overdrive parameters are overdrive gray-level values.

16. The liquid crystal display panel according to claim 9, wherein the timing control device further comprises a table lookup unit, the overdrive unit accesses the table lookup unit according to the i-th pieces of current frame data and the i-th piece of previous frame data so as to output the i-th overdrive parameter.

17. A method for generating overdrive parameters for use in a liquid crystal display panel, the method being for outputting M overdrive parameters according to a previous frame and a current frame, the previous frame including M pieces of previous frame data, and the current frame including M pieces of current frame data, the method comprising:
(a) at a first time point, storing an i-th one of the M pieces of current frame data in a first buffer unit of a first buffer device, where i is a positive integer not larger than M;
(b) storing an i-th one of the M pieces of previous frame data in a second buffer unit of a second buffer device, wherein at least a portion of the M pieces of previous frame data is stored in one of the first buffer device and the second buffer device;
(c) at a second time point, receiving the i-th piece of current frame data or one of the M pieces of previous frame data from the first buffer device by the second buffer unit; and
(d) outputting an i-th overdrive parameter which corresponds to the i-th piece of current frame data according to the i-th piece of previous frame data in the second buffer unit and the i-th piece of current frame data.

18. The method according to claim 17, wherein
in step (a), the first buffer device includes X first buffer units, the X first buffer units stores X of the M pieces of current frame data, wherein X is not larger than number of pieces of data in a pixel row of the current frame.

19. The method according to claim 18, wherein
in step (b), the second buffer device includes M second buffer units, the M second buffer units stores at least a portion of the M pieces of previous frame data.

20. The method according to claim 19, wherein
in step (c), at the second time point, the second buffer unit receives the i-th piece of current frame data from the first buffer device, and the second time point is subsequent to the first time point.

21. The method according to claim 18, wherein after the second time point, the second buffer device stores a first to the i-th ones of the M pieces of current frame data and an (i+1)-th to an M-th ones of the M pieces of previous frame data.

22. The method according to claim 17, wherein
in step (a), the first buffer device includes M first buffer units, the M first buffer units stores at least a portion of the M pieces of previous frame data and a first to the i-th pieces of current frame data.

23. The method according to claim 22, wherein
in step (b), the second buffer device includes X second buffer units, the X second buffer units stores X of the M pieces of previous frame data, wherein X is not larger than number of pieces of data in a pixel row of the previous frame.

24. The method according to claim 23, wherein
in step (c), at the second time point, the second buffer unit receives one of the pieces of previous frame data outputted from the first buffer device, and the second time point is prior to the first time point.

25. The method according to claim 22, wherein after the first time point, the first buffer device stores the first to the i-th ones of the M pieces of current frame data and an (i+1)-th to an M-th ones of the M pieces of previous frame data.

26. The method according to claim 17, wherein in step (d), the i-th overdrive parameter is outputted after accessing a table lookup unit according to the i-th pieces of current frame data and the i-th piece of previous frame data.

27. The method according to claim 17, wherein the overdrive parameters are overdrive gray-level values.
